(19) United States
(12) Patent Application Publication
(10) Pub. No.: US 2023/0092116 A1
(43) Pub. Date: Mar. 23, 2023

(54) Switchable Cutter Bar Drive for Agricultural Attachment

(71) Applicant: Carl Geringhoff GmbH Co. KG, AHLEN (DE)

(72) Inventors: Steffen Sudhues, Ahlen (DE); Michael Pokriefke, Hude (DE)

(21) Appl. No.: 17/898,579

(22) Filed: Aug. 30, 2022

(30) Foreign Application Priority Data
Sep. 17, 2021 (DE) 10 2021 124 148.0
Sep. 17, 2021 (DE) 102021124148.0

(51) Int. Cl. A01D 41/14; A01D 41/127

(52) U.S. Cl. CPC A01D 41/142; A01D 41/127

(57) ABSTRACT

An agricultural attachment is provided with a cutter bar and a hydraulic motor for oscillatingly driving the cutter bar via an eccentric gear. The hydraulic motor is connected via a feed line and a return line to a hydraulic loaded with a hydrostatic liquid by a hydraulic pump. A switchover valve is integrated in the hydraulic circuit and switches pressure-dependently, wherein the switchover valve has a first switch position and a second switch position and is adjustable back and forth between the first switch position and the second switch position. The hydraulic motor is driven in the first switch position in a first rotational direction and is driven in the second switch position in a second rotational direction, wherein the second rotational direction is opposite to the first rotational direction.

### BACKGROUND OF THE INVENTION

The present invention relates to an agricultural attachment with a cutter bar that is drivable oscillatingly by a hydraulic motor via an eccentric gear, wherein the hydraulic motor is connectable via a feed line and a return line to a hydraulic circuit which is loaded with a hydrostatic liquid by a hydraulic pump.

The publication US 2017/0105344 discloses a cutter bar drive for a header for attachment to a combine harvester. In this publication, it is not disclosed in detail whether the drive force for driving the drive shafts is generated purely mechanically directly by the internal combustion engine of the combine harvester or by a hydraulic motor. From the publication DE 20 2010 008 039 U1 it is known to drive a cutter bar hydraulically.

In operation of headers that are provided with a cutter bar, it can happen in case of a very tight crop stand but also in case of nests of weeds that the knife blades moved by the cutter bar can no longer completely cut the plants that are located in the cutting region and are to be cut by them in a cutting movement. The cutter bar jams and pulls the plants lodged in the cutter bar from the ground without them being supplied to further processing. Due to the jamming of the cutting region in which the plants that have not been completely cut are lodged, no additional plants can be cut there. Therefore, upon further advance of the combine harvester, cutting losses of uncut crop are produced. The same holds true for foreign bodies such as wood pieces, stones, and the like which may get into the active zone of the cutter bar and there may block the cutter bar. Here, damages are imminent due to deformed or broken-off knife blades which, in turn, lead to crop losses and repairs.

It is the object of the present invention to provide a solution as to how to release again possible blockages of the cutter bar in a manner that is as simple as possible without it being necessary for this purpose to stop the combine harvester, to manually eliminate the disturbance, and only thereafter continue the harvesting process.

### SUMMARY OF THE INVENTION

The object is solved for an agricultural attachment of the aforementioned kind in that in the hydraulic circuit a pressure-dependently switching switchover valve is integrated that comprises at least two different switch positions between which the switchover valve can be adjusted back and forth, and the hydraulic motor is driven in a first rotational direction in the first switch position of the switchover valve and, in the second switch position of the switchover valve, is driven in a second rotational direction that is opposite to the first rotational direction.

The solution according to the invention utilizes the fact that, in case of a beginning or already completely established blockage of the cutter bar by too much cut material and/or a foreign body in the region of the knives, the pressure in the feed line of the hydraulic circuit increases when the cutter bar can no longer move with the original speed because also the rotational speed of the hydraulic motor is reduced in case of a blockage of the cutter bar. Since the hydraulic motor swallows less hydraulic liquid for a reduced rotational speed in an identical time interval, the pressure in the feed line increases. This pressure increase is utilized by the pressure-dependently switching switchover valve for a switching action of the rotational direction of the hydraulic motor.

In this context, not any just minimal pressure increase must lead to a switching action of the movement direction. The switching action in this context can occur in particular only once the pressure in the feed line has surpassed a preadjusted threshold value. When switching, the switchover valve switches the connector of the hydraulic motor to the feed line and the return line in such a way that the rotational direction of the hydraulic motor and thus also the movement direction of the cutter bar change in the opposite direction.

For the cutting process in the cutter bar, the direction reversal means that a knife blade connected to the driven cutter bar and blocked in a cutting direction is moved in the opposite direction. The cut material that was jammed between the knife blade moved by the cutter bar and a stationary knife blade is thus released. It is no longer pulled out of the soil and entrained while being jammed. In this way, at least the already cut part of a plant bunch that is blocking the cutter bar can be conveyed into the attachment so that the plant loss is reduced by this alone. When the blocking cut material disappears from the blockage region, the previously blocked cutting zone is immediately released again and can take up new material to be cut for a new cut. Crop losses due to uncut crop are thus also reduced in this way. The hydraulic circuit can be designed in this context such that a reversal of the rotational direction of the hydraulic motor happens in a quickly changing sequence when the movable parts of the cutter bar cannot be moved back and forth without disturbance. Due to the quick succession of directional change, at the disturbance location a shaking effect is produced which additionally contributes to remove material packages and/or foreign bodies. Due to a directional change occurring multiple times in short succession, it is also possible to cut even material packages that could not have been cut anymore from the blocked position of the cutter bar when keeping the movement direction.

Finally, also the risk of damages of the knife blades by foreign bodies is reduced. When the cutting movement of a knife blade toward a foreign body located in the cutting region is stopped and the knife blade is then immediately moved in the opposite direction, the foreign body can fall out of the active region of the cutter bar because it is no longer held in a jammed position in the cutting region so that it can no longer cause further and greater damages at the knife blades anymore.

According to an embodiment of the invention, in the feed line of the hydraulic circuit upstream of the switchover valve in flow direction of the hydraulic liquid, a pressure limiting valve is arranged that comprises a relief opening that is pressure-connected to the actuation device for switching the switchover valve. When the trigger threshold value of the pressure limiting valve is surpassed by a pressure increase in the feed line, excess hydraulic liquid escapes through the relief opening from the pressure limiting valve into a pressure conduit which is connected to the actuation device of the switchover valve. The pressure of the escaping hydraulic liquid is utilized in the actuation device to actuate the switchover valve in that the latter is switched from a first switch position into a second switch position. It can be provided that excess hydraulic liquid contained in the pressure line is returned again into the tank of the hydraulic circuit so that the pressure line is immediately function-ready for a new switching action.

According to an embodiment of the invention, in the feed line of the hydraulic circuit upstream of the switchover valve in flow direction of the hydraulic liquid, a pressure sensor is arranged that is connected to the actuation device for switching the switchover valve and that transmits a control signal to the actuation device upon surpassing a preselected threshold value. Instead of a hydraulic switching action of the switchover valve, the switching action can also be triggered by a pressure sensor that, for example, generates an electronic control signal that is converted by the electrically driven or electrically switched actuation device into a switching action of the switchover valve.

According to an embodiment of the invention, the hydraulic motor can be switched on or switched off by a hydraulic multi-way valve. In order to be able to turn on and off the hydraulic motor, a corresponding switchable hydraulic valve is required. The hydraulic multi-way valve with which the hydraulic motor can be turned on and off can be the switchover valve that in a switching position, provided in addition to its switching positions required for reversal of the drive direction, separates the hydraulic motor at least from the feed line in order to turn it off.

According to an embodiment of the invention, the hydraulic motor, the switchover valve, and the pressure limiting valve or the pressure sensor are arranged together with a first part of the hydraulic circuit at the attachment, and the attachment comprises an interface by means of which the first part of the hydraulic circuit is connectable to a second part of the hydraulic circuit which is located in a combine harvester to which the agricultural attachment can be attached. In this distribution of the individual components of the hydraulic circuit, on the one hand, components such as, for example, the hydraulic pump and the tank already existing on the combine harvester can be utilized and then do not unnecessarily make the attachment more expensive and heavier, and, on the other hand, precisely those components can be arranged on the attachment that are required specifically for the realization of the function of the movement direction reversal. The interface can be configured as a hydraulic coupling by means of which the attachment is connectable to the hydraulic circuit of the combine harvester.

Further features of the invention result from the claims, the Figures, and the subject matter description. All features and feature combinations which have been mentioned before in the description as well as the features and feature combinations mentioned in the following in the figure description and/or shown alone in the Figures are not only useable in the respectively disclosed combination but also in other combinations and also individually.

The invention will now be explained in more detail with the aid of a preferred embodiment as well as with reference to the attached drawing.

### BRIEF DESCRIPTION OF THE DRAWING

FIG. 1 shows an agricultural attachment 2 that can be attached to a combine harvester and is provided with a cutter bar 20.

### DESCRIPTION OF PREFERRED EMBODIMENTS

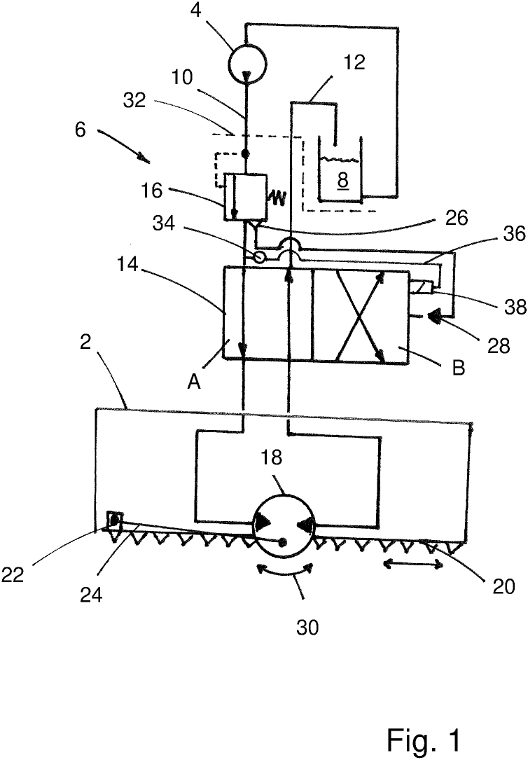

In FIG. 1, an agricultural attachment 2 is illustrated that can be attached to a combine harvester, not illustrated here. The agricultural attachment 2 can be, for example, a grain header or a mower. A cutter bar 20 is arranged at the attachment 2 and, during harvesting, is moved into the standing crop and in doing so cuts the stalks of the crop. The cut crop is then pulled in by the attachment 2 and conveyed to the associated combine harvester.

The attachment 2 is provided with a hydraulic circuit 6 through which a hydraulic liquid is circulating which is supplied by the hydraulic pump 4. The hydraulic liquid is sucked in by the hydraulic pump 4 from the tank 8 and pumped into the feed line 10. Through the return line 12, the hydraulic liquid is returned again to the tank 8 after it has passed through the hydraulic motor 18.

Between the hydraulic pump 4 and the tank 8, on the one hand, and the hydraulic motor 18, on the other hand, a switchover valve 14 is provided in the hydraulic circuit 8. The hydraulic motor 18 is designed to operate in two rotational directions 30. Depending on the rotational direction, the hydraulic motor 18 moves the cutter bar 20 via an eccentric gear 22 to the right or to the left. In the embodiment, the eccentric gear 22 is comprised of a hydraulic motor-side drive disk, a coupling rod 24 which is eccentrically connected to the drive disk, and a bearing pin that is connected rigidly to the movable part of the cutter bar 20. By means of the eccentric gear, the rotational movement of the drive disk is converted into an oscillating movement of the movable part of the cutter bar 20.

The direction in which the hydraulic motor 18 rotates depends on in which switch position the switchover valve 14 is arranged. In FIG. 1, a 4/2 way valve is illustrated with which the hydraulic motor 18 is driven in opposite direction in the two illustrated switch positions A, B, respectively. When the switch position of the switchover valve 14 is changed from the switch position A into the switch position B or vice versa, the movement direction of the movable part of the cutter bar 20 is immediately changed mandatorily in this way.

In the embodiment illustrated in FIG. 1, a pressure limiting valve 16 is located in the feed line 10 between the hydraulic pump 4 and the switchover valve 14. When in the feed line 10 a pressure exists that surpasses a preadjusted threshold value, a relief opening 26 opens through which the hydraulic liquid can escape from the pressure limiting valve 16. The hydraulic liquid which is escaping from the pressure limiting valve 16 acts on the pressure actuation 28 with which the switchover valve 14 can be switched back and forth between one of the switch positions A, B. Thus, when in the feed line 10 an excess pressure occurs, the rotational direction of the hydraulic motor 18 changes automatically.

In FIG. 1, the interface 32 between an attachment 2 and a combine harvester to which the attachment 2 can be attached is indicated by a dashed line. In the proposed distribution, the hydraulic pump 4 and the tank 8 are located on the combine harvester while the other components of the hydraulic circuit 6 are arranged at the attachment 2.

Instead of the switching action of the switchover valve 14 by the pressure limiting valve 16, it is also possible to effect the switching action of the switchover valve 14 by a pressure sensor 34. The pressure sensor 34 measures continuously the pressure which is present in the feed line 10. When surpassing of a threshold value is detected in this context, the pressure sensor 34 reports the excess pressure in the feed line 10 via a sensor line 36 to the electric actuation 38 which then switches the switchover valve 14.

The invention is not limited to the aforementioned example. A person of skill in the art will have no difficulties in modifying the embodiment in a way appearing suitable to him in order to adapt it to a concrete application situation.

### LIST OF REFERENCE CHARACTERS

2 agricultural attachment
4 hydraulic pump
6 hydraulic circuit
8 tank
10 feed line
12 return line
14 switchover valve
16 pressure limiting valve
18 hydraulic motor
20 cutter bar
22 eccentric gear
24 coupling rod
26 relief opening
28 pressure actuation
30 rotational direction
32 interface
34 pressure sensor
36 sensor line
38 electrical actuation

What is claimed is:

1. An agricultural attachment comprising:
a cutter bar;
a hydraulic motor configured to oscillatingly drive the cutter bar via an eccentric gear;
a hydraulic circuit loaded with a hydrostatic liquid by a hydraulic pump, wherein the hydraulic motor is configured to connect via a feed line and a return line to the hydraulic circuit;
a switchovervalve integrated in the hydraulic circuit and configured to switch pressure-dependently, wherein the switchover valve comprises a first switch position and a second switch position and is configured to be adjusted back and forth between the first switch position and the second switch position;
wherein the hydraulic motor is driven in the first switch position in a first rotational direction and is driven in the second switch position in a second rotational direction, wherein the second rotational direction is opposite to the first rotational direction.

2. The agricultural attachment according to claim 1, further comprising a pressure limiting valve arranged in the feed line of the hydraulic circuit upstream of the switchover valve in a flow direction of the hydraulic liquid, wherein the pressure limiting valve comprises a relief opening, wherein the relief opening is pressure-connected to an actuation device configured to switch the switchover valve.

3. The agricultural attachment according to claim 2, wherein the hydraulic motor, the switchover valve, the pressure limiting valve, and a first part of the hydraulic circuit are arranged at the agricultural attachment, wherein the agricultural attachment further comprises an interface, wherein the interface is configured to connect the first part of the hydraulic circuit to a second part of the hydraulic circuit located in a combine harvester to which the agricultural attachment is attachable.

4. The agricultural attachment according to claim 1, further comprising a pressure sensor arranged in the feed line of the hydraulic circuit upstream of the switchover valve in a flow direction of the hydraulic liquid, wherein the pressure sensor is connected to an actuation device configured to switch the switchover valve and configured to transmit a control signal to the actuation device when a preselected threshold value is surpassed.

5. The agricultural attachment according to claim 4, wherein the hydraulic motor, the switchover valve, the pressure sensor, and a first part of the hydraulic circuit are arranged at the agricultural attachment, wherein the agricultural attachment further comprises an interface, wherein the interface is configured to connect the first part of the hydraulic circuit to a second part of the hydraulic circuit located in a combine harvester to which the agricultural attachment is attachable.

6. The agricultural attachment according to claim 1, wherein the hydraulic motor is configured to be switched on and off by a hydraulic multi-way valve.
